(19) United States
(12) Patent Application Publication
(10) Pub. No.: US 2011/0224070 A1
(43) Pub. Date: Sep. 15, 2011

(54) MICROPOROUS CARBON MATERIAL AND METHODS OF FORMING SAME

(75) Inventors: Gregory P. Meisner, Ann Arbor, MI (US); Qingyuan Hu, East Brunswick, NJ (US)

(73) Assignee: GM GLOBAL TECHNOLOGY OPERATIONS, INC., Detroit, MI (US)

(21) Appl. No.: 12/720,730

(22) Filed: Mar. 10, 2010

(51) Int. Cl. C01B 31/12

(52) U.S. Cl. 502/418

(57) ABSTRACT

A method of forming a microporous carbon material includes combining a carbon precursor in solid form and an activation reagent in solid form to form a mixture, ball milling the mixture to form a composite, and, after ball milling, simultaneously activating and carbonizing the composite to form the microporous carbon material. The microporous carbon material includes a reaction product of the carbon precursor in solid form and the activation reagent in solid form. The microporous carbon material defines a plurality of micropores, a plurality of mesopores, and a plurality of macropores, wherein the plurality of micropores are present in the microporous carbon material in an amount greater than or equal to about 90 parts by volume based on 100 parts by volume of the microporous carbon material. The microporous carbon material has a surface area of from about 1,400 m²/g to about 3,400 m²/g.

### TECHNICAL FIELD

The present disclosure relates to a microporous carbon material and methods of forming such a microporous carbon material.

### BACKGROUND OF THE INVENTION

Hydrogen storage is often required for applications using hydrogen gas. For example, applications such as gas purification and separation, gas capture, catalysis, electrodes for fuel cells and super capacitors, and gas storage may require hydrogen gas to be stored in hydrogen storage media that is suitable for adsorbing and releasing hydrogen. One type of hydrogen storage media, porous carbon material, e.g., activated carbon, mesoporous carbon, porous carbon fiber, and carbide-derived carbon, may be suitable for commercial and industrial applications requiring stable, economical hydrogen storage.

### SUMMARY OF THE INVENTION

A method of forming a microporous carbon material includes combining a carbon precursor in solid form and an activation reagent in solid form to form a mixture. The method further includes ball milling the mixture to form a composite, and, after ball milling, simultaneously activating and carbonizing the composite to form the microporous carbon material.

In another variation, the method includes combining a phenolic resin polymer in solid form and potassium hydroxide in solid form in a weight ratio of potassium hydroxide to phenolic resin polymer of about 4.1 to form the mixture. The method further includes ball milling the mixture in solid form for about 60 minutes to thereby substantially homogeneously disperse the potassium hydroxide in solid form throughout the phenolic resin polymer in solid form to form a composite. After ball milling, the method includes simultaneously activating and carbonizing the composite at a temperature of about 700° C. for from about 3 hours to about 6 hours to form the microporous carbon material, wherein the microporous carbon material has a surface area of from greater than about 3,000 m²/g to about 3,400 m²/g.

A microporous carbon material includes a reaction product of a carbon precursor in solid form and an activation reagent in solid form. The microporous carbon material defines a plurality of micropores each having a width of less than about 2 nm, a plurality of mesopores each having a width of from about 2 nm to about 50 nm, and a plurality of macropores each having a width of greater than about 50 nm. The plurality of micropores are present in the microporous carbon material in an amount greater than or equal to about 90 parts by volume based on 100 parts by volume of the microporous carbon material. Further, the microporous carbon material has a surface area of from about 1,400 m²/g to about 3,400 m²/g.

The microporous carbon material exhibits excellent surface area and substantially uniform micropore size distribution. Further, the microporous carbon material is comparatively efficient and economical to prepare, e.g., via the method. That is, the method efficiently and economically maximizes a yield of microporous carbon material. Moreover, since the microporous carbon material is chemically and physically stable, the microporous carbon material is suitable for a range of applications requiring ease of handling.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic flow diagram of a method of forming a microporous carbon material;

FIG. 2 is a graphical representation of a relationship between nitrogen adsorption and relative pressure for microporous carbon materials formed by combining an activation reagent and a carbon precursor in various weight ratios according to the method of FIG. 1;

FIG. 3 is a graphical representation of a relationship between Brunauer, Emmett, and Teller (BET) surface area and the weight ratio of activation reagent to carbon precursor for microporous carbon materials formed by the method of FIG. 1;

FIG. 4 is a graphical representation of a relationship between BET surface area, pore volume, and average pore width for microporous carbon materials formed by the method of FIG. 1;

FIG. 5 is a graphical representation of a relationship between BET surface area and a duration of simultaneous activation and carbonization for microporous carbon materials formed by the method of FIG. 1;

FIG. 6 is a graphical representation of a relationship between BET surface area and a temperature of simultaneous activation and carbonization for microporous carbon materials formed by the method of FIG. 1;

FIG. 7 is a graphical representation of a relationship between BET surface area and ball milling duration for microporous carbon materials formed by the method of FIG. 1;

FIG. 8 is a graphical representation of a relationship between excess hydrogen adsorption capacity and pressure for microporous carbon materials formed by the method of FIG. 1; and

FIG. 9 is a graphical representation of a relationship between excess hydrogen adsorption capacity and BET surface area for microporous carbon materials formed by the method of FIG. 1.

### DESCRIPTION OF THE PREFERRED EMBODIMENTS

A microporous carbon material and a method of forming the microporous carbon material are described herein. The microporous carbon material and the method may be useful for applications requiring hydrogen storage media, e.g., automotive applications such as fuel storage and fuel cell and battery electrodes. However, the microporous carbon material and method may also be useful for non-automotive applications such as, but not limited to, catalysis, gas purification and separation, gas capture, adsorbents, and electrodes for super capacitors. Further, the microporous carbon material has extremely high surface area and therefore may be referenced as a super-activated microporous carbon material and/or a high surface area microporous carbon material.

The microporous carbon material includes a reaction product of a carbon precursor in sold form and an activation reagent in solid form. In particular, the carbon precursor may be useful as a source of carbon for the microporous carbon material. The carbon precursor is provided in solid form, e.g., in powder form, and may have an average particle size of from about 0.001 mm to about 1 mm.

Suitable carbon precursors in solid form may be selected from the group including solid carbonizable polymers, lignocellulosic materials, thermally carbonizable biomass wastes, and combinations thereof. Moreover, suitable carbon precursors may be formed from suitable starting materials such as, but not limited to, phenolic resin oligomers, resorcinol, and phloroglucinol-based resin oligomers. Selection of the starting materials and/or the carbon precursor may be determined by the desired chemical and/or physical characteristics of the microporous carbon material.

In one non-limiting example, the carbon precursor may be a phenolic resin polymer, formed by a reaction of phenol and formaldehyde. For example, the carbon precursor may be prepared by reacting phenol and formaldehyde in aqueous solution in the presence of a catalyst, e.g., potassium hydroxide solution, to form the phenolic resin oligomer. In particular, phenol and formaldehyde may be reacted in a liquid medium such as water or a mixture of water and alcohol, e.g., ethanol. The phenolic resin oligomer may then be washed, e.g., with potassium hydroxide, and dried in an oven at a temperature of about 160° C. for about 24 hours to crosslink and polymerize the phenolic resin oligomer to thereby form the phenolic resin polymer, i.e., the carbon precursor.

The activation reagent in solid form may be useful for chemically activating the carbon precursor to form the microporous carbon material, as set forth in more detail below. In particular, the activation reagent may be useful for defining a plurality of micropores, a plurality of mesopores, and a plurality of macropores of the microporous carbon material, as also set forth in more detail below. Suitable activation reagents in solid form may be selected from the group including potassium hydroxide, sodium hydroxide, potassium carbonate, sodium carbonate, and combinations thereof. In one non-limiting example, the activation reagent may be potassium hydroxide in solid form, e.g., in powder form.

The microporous carbon material defines a plurality of micropores each having a width of less than about 2 nm, a plurality of mesopores each having a width of from about 2 nm to about 50 nm, and a plurality of macropores each having a width of greater than about 50 nm. Therefore, a total pore volume of the microporous carbon material may be defined as the total volume of the plurality of micropores, the plurality of mesopores, and the plurality of macropores defined by the microporous carbon material.

The plurality of micropores are present in the microporous carbon material in an amount greater than or equal to about 90 parts by volume based on 100 parts by volume of the microporous carbon material. Stated differently, the plurality of mesopores and the plurality of macropores in combination are present in the microporous carbon material in an amount less than or equal to about 10 parts by volume based on 100 parts by volume of the microporous carbon material. Therefore, the micropores make up a substantial majority of the total pore volume of the microporous carbon material, and the microporous carbon material has a substantially uniform pore size distribution. As used herein, the terminology “substantially uniform pore size distribution” indicates that the plurality of micropores, each having a width of less than about 2 nm, make up 90% or more of the total pore volume of the microporous carbon material. As such, the microporous carbon material does not have a broad distribution of pore sizes, but rather has a substantially uniform pore size distribution.

The microporous carbon material also has a surface area of from about 1,400 m²/g to about 3,400 m²/g as determined by Brunauer, Emmett, and Teller (BET) nitrogen sorption surface area measurement. For example, the microporous carbon material may have a surface area of from about 3,000 m²/g to about 3,400 m²/g, e.g., 3,390 m²/g. Moreover, the microporous carbon material has an excess hydrogen adsorption capacity at a pressure less than or equal to about 35 bar and a temperature of about 77K of from about 3.6 parts by weight to about 6.0 parts by weight based on 100 parts by weight of hydrogen. That is, the excess hydrogen adsorption capacity of the microporous carbon material is from about 3.6 wt % to about 6.0 wt % at a pressure of about 30 bar and a temperature of about 77K.

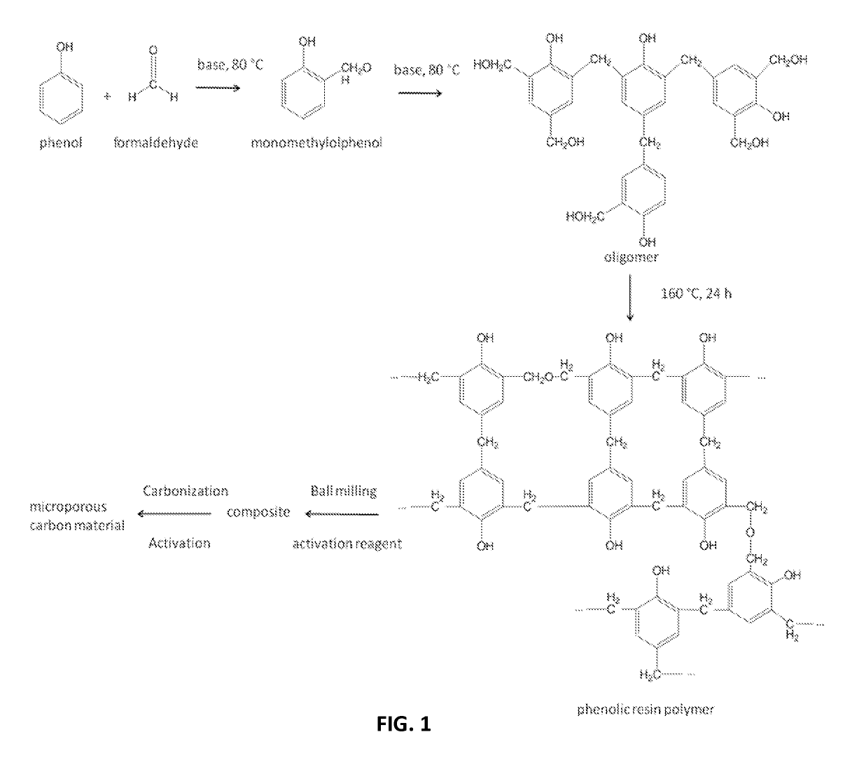

Referring now to FIG. 1, the method of forming the microporous carbon material includes combining the carbon precursor in solid form and the activation reagent in solid form to form a mixture. The carbon precursor and the activation reagent may be combined in any suitable manner and in any suitable order of addition. That is, the activation reagent may be added to the carbon precursor, or the carbon precursor may be added to the activation reagent.

The method may further include controlling the surface area of the microporous carbon material to from about 1,400 m²/g to about 3,400 m²/g. In particular, the method may further include controlling the surface area of the microporous carbon material by controlling a weight ratio of the activation reagent to the carbon precursor. That is, combining may mix the activation reagent and the carbon precursor in the weight ratio of activation reagent to carbon precursor of from about 0.5:1 to about 6:1, e.g., from about 3:1 to about 6:1, to form the mixture. Without intending to be limited by theory, relatively higher weight ratios of activation reagent to carbon precursor may contribute to relatively larger pore sizes and pore volume, as set forth in more detail below. At the weight ratio of activation reagent to carbon precursor of about 4:1, the surface area of the microporous carbon material may be about 3,390 m²/g, e.g., 3,388 m²/g.

Referring to FIG. 1, the method may also include preparing the carbon precursor in solid form before combining As set forth above, the carbon precursor may be prepared by reacting phenol and formaldehyde in aqueous solution in the presence of a catalyst to form the phenolic resin oligomer. The phenolic resin oligomer may then be washed and dried in an oven at a temperature of about 160° C. for about 24 hours to crosslink and polymerize the phenolic resin oligomer to thereby form the phenolic resin polymer, i.e., the carbon precursor.

Referring again to FIG. 1, the method also includes ball milling the mixture to form a composite. As used herein, the terminology “ball milling” refers to a mechanical process in which the mixture is subjected to repeated collisions with grinding balls to cause deformation, fracture, and microstructural refinement of the mixture. Ball milling may substantially homogeneously disperse the activation reagent in solid form throughout the carbon precursor in solid form to form the composite. Ball milling may be performed by any suitable ball milling apparatus, such as a planetary ball mill or a centrifugal ball mill. Suitable grinding balls may be formed from, for example, ceramic, stainless steel, lead, antimony, brass, bronze, flint, and combinations thereof, and may have a width of at least 0.05 mm. In operation, the ball milling device may agitate the mixture of the carbon precursor and the activation reagent so that the grinding balls mechanically crush and mix the mixture. Further, ball milling may occur in air or in an inert atmosphere, e.g., in argon gas.

Processing parameters such as, but not limited to, speed of ball milling, acceleration, time of ball milling, grinding ball size, and a ratio of volume of grinding balls to volume of mixture, may each be selected according to desired properties of the composite. Further, selection of one of the aforementioned processing parameters may determine another processing parameter. That is, the aforementioned processing parameters may be interrelated.

The method may further include controlling the surface area of the microporous carbon material by controlling a duration of ball milling. That is, a desired high surface area of the microporous carbon material may be achieved by sufficiently controlling the duration of ball milling. In particular, the duration of ball milling may be from about 15 minutes to about 120 minutes. Without intending to be limited by theory, the duration of ball milling determines a degree of mixing and homogeneity of the mixture of the carbon precursor and the activation reagent. For example, increasing the duration of ball milling from about 15 minutes to about 60 minutes may increase the surface area of the microporous carbon material from about 2,200 m²/g to about 2,700 m²/g.

Further, ball milling may reduce the average particle size of the carbon precursor to less than or equal to about 100 microns. That is, ball milling the mixture for about 15 minutes may reduce the average particle size of the carbon precursor to about 100 microns, and ball milling the mixture for about 1 hour may reduce the average particle size of the carbon precursor to about 50 microns. Therefore, as compared to the mixture before ball milling, the composite in solid form formed after ball milling includes the activation reagent substantially homogeneously dispersed throughout the carbon precursor, wherein the carbon precursor has an average particle size of less than or equal to about 100 microns.

Referring again to FIG. 1, the method further includes, after ball milling, simultaneously activating and carbonizing the composite to form the microporous carbon material. As used herein, the terminology “carbonizing” refers to heating the composite to convert the composite, which includes the carbon precursor, to carbon. In particular, heating the composite burns off any non-carbon elements present in the composite, and thereby converts the composite to a carbon material. Further, as used herein, the terminology “activating” refers to chemically activating the composite via the activation reagent to form the microporous carbon material. That is, the activation reagent may act on the carbon precursor to define the plurality of micropores, the plurality of mesopores, and the plurality of macropores. More specifically, simultaneously activating and carbonizing defines the plurality of micropores each having a width of less than about 2 nm, the plurality of mesopores each having a width of from about 2 nm to about 50 nm, and the plurality of macropores each having a width of greater than about 50 nm of the microporous carbon material so that the plurality of micropores are present in the microporous carbon material in an amount greater than or equal to about 90 parts by volume based on 100 parts by volume of the microporous carbon material.

For variations including potassium hydroxide as the activation reagent, at elevated activation temperatures, simultaneous activation and carbonation proceeds as potassium hydroxide etches away carbon atoms of the carbon precursor. More specifically, potassium hydroxide may react with carbon to cause carbon gasification via the oxygen of the potassium hydroxide. That is, during carbon gasification, carbon may be oxidized to carbon monoxide and/or carbon dioxide. Such etching away of carbon atoms thereby defines the plurality of micropores, the plurality of mesopores, and the plurality of macropores. Consequently, the total pore volume is increased and individual walls of each micro-, meso-, and macropore are thinned, which in turn reduces a weight of carbon in the carbon precursor.

The method may further include controlling the surface area of the microporous carbon material by controlling a temperature of simultaneously activating and carbonizing. Additionally or alternatively, the method may further include controlling the surface area of the microporous carbon material by controlling a duration of simultaneously activating and carbonizing. More specifically, simultaneously activating and carbonizing the composite may heat the composite to a temperature of from about 500° C. to about 900° C. for from about 0.5 hours to about 8 hours. In one non-limiting example, simultaneously activating and carbonizing may heat the composite to a temperature of about 700° C. for about 4 hours to form the microporous carbon material.

Referring again to FIG. 1, the method may further include purifying the microporous carbon material after simultaneously activating and carbonizing the composite. That is, impurities may exist in the formed microporous carbon material, and the method may further include removing impurities from the microporous carbon material. For example, after simultaneously activating and carbonizing, the microporous carbon material may be washed with a solvent, e.g., dilute hydrochloric acid and hot water, several times to remove residual activation reagent and then dried in air at a temperature of about 150° C. for about 24 hours.

In one variation of the method, the method includes combining the phenolic resin polymer in solid form and potassium hydroxide in solid form in the weight ratio of potassium hydroxide to phenolic resin polymer of about 4:1 to form the mixture. The method further includes ball milling the mixture in solid form for about 60 minutes to thereby substantially homogeneously disperse the potassium hydroxide in solid form throughout the phenolic resin polymer in solid form to form the composite. After ball milling, the method includes simultaneously activating and carbonizing the composite at a temperature of about 700° C. for from about 3 hours to about 6 hours to form the microporous carbon material, wherein the microporous carbon material has a surface area of from greater than about 3,000 m²/g to about 3,400 m²/g.

The microporous carbon material exhibits excellent surface area and substantially uniform micropore size distribution. Further, the microporous carbon material is comparatively efficient and economical to prepare, e.g., via the method. That is, the method efficiently and economically maximizes a yield of microporous carbon material. Moreover, since the microporous carbon material is chemically and physically stable, the microporous carbon material is suitable for a range of applications requiring ease of handling.

The following examples are meant to illustrate the aforementioned disclosure and are not to be viewed in any way as limiting to the scope of the disclosure.

### EXAMPLES

### Sample Preparation

A phenolic resin oligomer is synthesized by reacting 13 mmol phenol, 26 mmol formaldehyde, and 1.3 mmol potassium hydroxide at 80° C. for about 1 hour in an aqueous solution. The phenolic resin oligomer is washed with de-ionized water and heated in an oven to 160° C. for 24 hours. During the heating, any solvent, e.g., water or water and alcohol, evaporates, and cross-linking of the phenolic resin oligomer is initiated. The phenolic resin oligomer crosslinks and polymerizes to form a thermoset, phenolic resin polymer, i.e., a carbon precursor in solid form. The carbon precursor in black powder form is washed with dilute hydrochloric acid and hot water 3 times to remove residual potassium hydroxide and any impurities, and dried in air at 150° C. for 24 hours.

As summarized in Tables 1 and 2, various mixtures, corresponding to samples C-1 through C-10 are prepared by combining the phenolic resin polymer in solid form with potassium hydroxide in solid form in various weight ratios of potassium hydroxide to phenolic resin polymer. Further, each mixture corresponding to samples C-1 through C-10 is ball milled in a planetary ball mill including stainless steel ball bearings for 60 minutes in air to form composites corresponding to samples C-1 through C-10, as summarized in Table 2. After ball milling, each composite corresponding to samples C-1 through C-10 is simultaneously activated and carbonized at 700° C. for 4 hours to form microporous carbon materials corresponding to samples C-1 through C-10, as also summarized in Table 2.

Samples C-11, C-14, C-16, and C-19 through C-26 are also prepared by combining the phenolic resin polymer in solid form with potassium hydroxide in solid form in various weight ratios of potassium hydroxide to phenolic resin polymer, as summarized in Table 3. Further, each mixture corresponding to samples C-11, C-14, C-16, and C-19 through C-26 is ball milled in a planetary ball mill including stainless steel ball bearings for various times in air to form composites corresponding to samples C-11, C-14, C16, and C-19 through C-26, as summarized and compared to composites corresponding to each of samples C-4 and C-8 in Table 3. After ball milling, each composite corresponding to samples C-11, C-14, C-16, and C-19 through C-26 is simultaneously activated and carbonized for various activation times and activation temperatures to form microporous carbon materials corresponding to samples C-11, C-14, C-16, and C-19 through C-26, as also summarized and compared to microporous carbon materials corresponding to samples C-4 and C-8 in Table 3.

Sample Characterization

Each of samples C-1 through C-11, C-14, C-16, and C-19 through C-26 is characterized using Brunauer, Emmett, and Teller (BET) nitrogen sorption surface area measurements via a Micromeritics ASAP 2010 device operation at 77K. Further, cryogenic hydrogen sorption measurements at high pressures are performed on each of samples C-1 through C-11, C-14, C-16, and C-19 through C-26 via a Hy-Energy Scientific Instruments PCTPro 2000 device at 77K and room temperature.

TABLE 1
Brunauer, Emmett, and Teller (BET) Specific Surface Areas, Pore Volumes, and Pore Widths
for Various KOH/Phenolic Resin Polymer Weight Ratios for Microporous Carbon Materials

| | Weight Ratio | | Pore Volume | Pore Volume | Pore Volume | Average |
|---|---|---|---|---|---|---|
| | of KOH to | BET Specific | for Width < | for 1.7 nm < | for Width < | Pore |
| | Phenolic | Surface Area | 77 nm | Width < 300 nm | 1.7 nm | Width |
| Sample | Resin Polymer | (m²/g) | (cm³/g) | (cm³/g) | (cm³/g) | (nm) |
| C-1 | 0.5:1 | 1620 | 0.66 | 0.08 | 0.58 | 1.63 |
| C-2 | 1:1 | 1940 | 0.78 | 0.07 | 0.71 | 1.60 |
| C-3 | 1.5:1 | 2530 | 1.13 | 0.27 | 0086 | 1.78 |
| C-4 | 2:1 | 2710 | 1.25 | 0.40 | 0.85 | 1.85 |
| C-5 | 2.5:1 | 2940 | 1.50 | 0.80 | 0.69 | 2.04 |
| C-6 | 3:1 | 3210 | 1.93 | 1.55 | 0.38 | 2.40 |
| C-7 | 3.5:1 | 3250 | 2.14 | 2.14 | 0.00 | 2.64 |
| C-8 | 4:1 | 3390 | 2.18 | 1.90 | 0.28 | 2.58 |
| C-9 | 5:1 | 3300 | 2.30 | 2.21 | 0.09 | 2.78 |
| C-10 | 6:1 | 3170 | 2.14 | 2.10 | 0.04 | 2.70 |

TABLE 2
Brunauer, Emmett, and Teller (BET) Specific Surface
Areas, Ball Milling Times, Activation Temperatures,
and Activation Times for Various KOH/Phenolic Resin
Polymer Weight Ratios for Microporous Carbon Materials

| | Weight Ratio | BET | | | |
|---|---|---|---|---|---|
| | of KOH to | Specific | | | |
| | Phenolic | Surface | Ball | Activation | Activation |
| | Resin | Area | Milling | Temperature | Time |
| Sample | Polymer | (m²/g) | Time (min) | (° C.) | (hours) |
| C-1 | 0.5:1 | 1620 | 60 | 700 | 4 |
| C-2 | 1:1 | 1940 | 60 | 700 | 4 |
| C-3 | 1.5:1 | 2530 | 60 | 700 | 4 |
| C-4 | 2:1 | 2710 | 60 | 700 | 4 |
| C-5 | 2.5:1 | 2940 | 60 | 700 | 4 |
| C-6 | 3:1 | 3210 | 60 | 700 | 4 |
| C-7 | 3.5:1 | 3250 | 60 | 700 | 4 |
| C-8 | 4:1 | 3390 | 60 | 700 | 4 |
| C-9 | 5:1 | 3300 | 60 | 700 | 4 |
| C-10 | 6:1 | 3170 | 60 | 700 | 4 |

TABLE 3
BET Specific Surface Areas for Various Synthesis
Conditions for Microporous Carbon Materials

| | Weight Ratio | BET | | | |
|---|---|---|---|---|---|
| | of KOH to | Specific | | | |
| | Phenolic | Surface | Ball | Activation | Activation |
| | Resin | Area | Milling | Temperature | Time |
| Sample | Polymer | (m²/g) | Time (min) | (° C.) | (hours) |
| C-11 | 2:1 | 2190 | 15 | 700 | 4 |
| C-14 | 2:1 | 2630 | 30 | 700 | 4 |
| C-4 | 2:1 | 2710 | 60 | 700 | 4 |
| C-16 | 2:1 | 2650 | 120 | 700 | 4 |
| C-19 | 4:1 | 1450 | 60 | 500 | 4 |
| C-20 | 4:1 | 2940 | 60 | 600 | 4 |
| C-8 | 4:1 | 3390 | 60 | 700 | 4 |
| C-21 | 4:1 | 3110 | 60 | 800 | 4 |
| C-22 | 4:1 | 3100 | 60 | 900 | 4 |
| C-23 | 4:1 | 2110 | 60 | 700 | 0.5 |
| C-24 | 4:1 | 2710 | 60 | 700 | 1 |
| C-25 | 4:1 | 3240 | 60 | 700 | 2 |
| C-8 | 4:1 | 3390 | 60 | 700 | 4 |
| C-26 | 4:1 | 2800 | 60 | 700 | 8 |

Results

Substantially Uniform Pore Distribution

Microporous carbon materials are obtained using the method disclosed herein. As summarized in Table 1, each microporous carbon material corresponding to samples C-1 through C-6 and C-8 through C-10 defines a plurality of micropores each having a width of less than about 2 nm, a plurality of mesopores each having a width of from about 2 nm to about 50 nm, and a plurality of macropores each having a width of greater than about 50 nm. In contrast, the microporous carbon material corresponding to sample C-7 defines a plurality of mesopores each having a width of from about 2 nm to about 50 nm and a plurality of macropores each having a width of greater than about 50 nm.

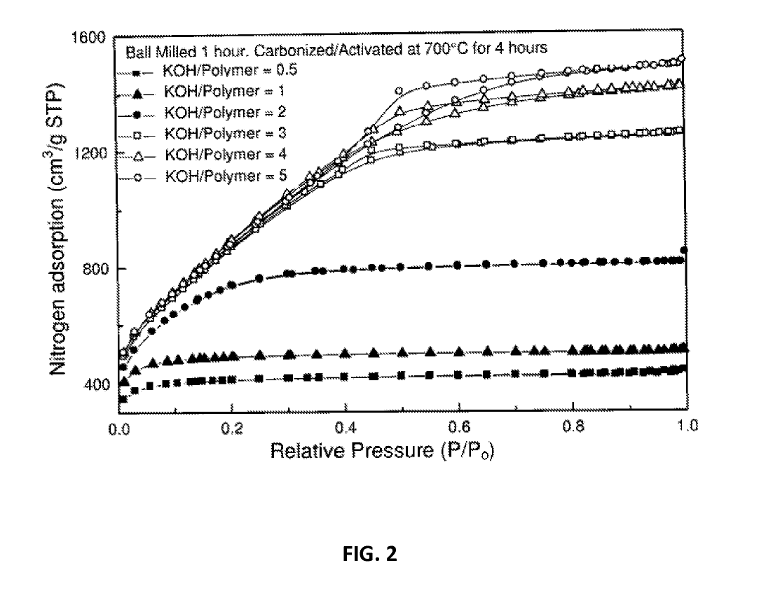

FIG. 2 illustrates nitrogen adsorption isotherms for microporous carbon materials corresponding to each of samples C-1, C-2, C-4, C-6, C-8, and C-9. The phenolic resin polymer, i.e., the carbon precursor, is combined with potassium hydroxide, i.e., the activation reagent, in various weight ratios to form the mixtures. The mixtures are ball milled for 60 minutes to form composites, and the composites are simultaneously activated and carbonized at 700° C. for 4 hours. Relative pressure P/P₀ represents an applied nitrogen pressure, P, divided by the equilibrium saturation vapor pressure of nitrogen, P₀, at 77K.

As shown in FIG. 2, significant nitrogen uptake at relative pressures P/P₀<2 indicates an existence of the plurality of micropores each having a width of less than about 2 nm. Similarly, an absence of significant nitrogen uptake near P/P₀=1 indicates an absence of any appreciable amount of a plurality of interparticle textural pores, i.e., pores spanning individual particles of the microporous carbon material. Further, for weight ratios less than or equal to 2:1 (samples C-1, C-2, and C-4), the nitrogen adsorption isotherms of FIG. 2 exhibit Type I isotherm behavior consistent with defining the plurality of micropores. Additionally, for weight ratios less than or equal to 2:1 (samples C-1, C-2, and C-4), the flat nitrogen adsorption isotherms of FIG. 2 at P/P₀>0.4 indicate an absence of comparatively larger pores, e.g., macropores. Therefore, as the weight ratio of potassium hydroxide to phenolic resin polymer increases, nitrogen adsorption of the microporous carbon materials also increases at both low and high pressures. Such nitrogen adsorption indicates an increase in both micropore volume and total pore volume.

Referring again to FIG. 2, for weight ratios of greater than 2:1 (samples C-6, C-8, and C-9), hysteresis loops are evident and indicate a definition of mesopores. Additionally, for weight ratios of greater than 2:1 (samples C-6, C-8, and C-9), the nitrogen adsorption isotherms gradually transform from Type Ito Type IV isotherms. Further, the nitrogen adsorption isotherms for the microporous carbon materials corresponding to samples C-6, C-8, and C-9 indicate significant nitrogen uptake at P/P₀=0.2 through 0.8. Such nitrogen uptake indicates the plurality of mesopores defined during the simultaneous activation and carbonization of the composites. The nitrogen adsorption isotherms of FIG. 2 also indicate very low additional nitrogen adsorption at higher relative pressures, and therefore further indicate a small number of macropores.

Brunauer, Emmett, and Teller (BET) Surface Area

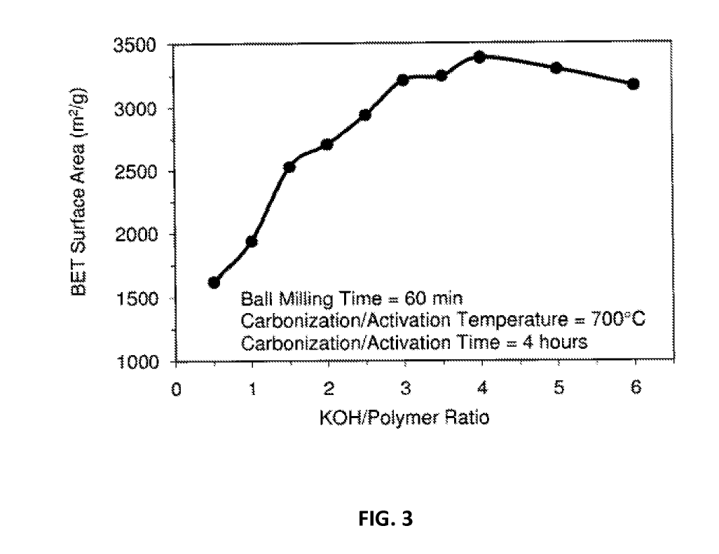

Table 1 summarizes the Brunauer, Emmett, and Teller (BET) surface area analysis of the nitrogen adsorption isotherms of FIG. 2 for the microporous carbon materials corresponding to samples C-1, C-2, C-4, C-6, C-8, and C-9. By way of general explanation, adsorption isotherms illustrate an amount of a gas adsorbed on a solid at different pressures, but at one temperature. As shown in FIG. 3, BET surface area has a strong dependence on the weight ratio of activation reagent to carbon precursor. For example, referring to FIG. 3, a weight ratio of 1:1 (sample C-2) provides a microporous carbon material having a BET surface area of 1,940 m²/g, while a weight ratio of 4:1 (sample C-8) provides a microporous carbon material having a BET surface area of 3,390 m²/g.

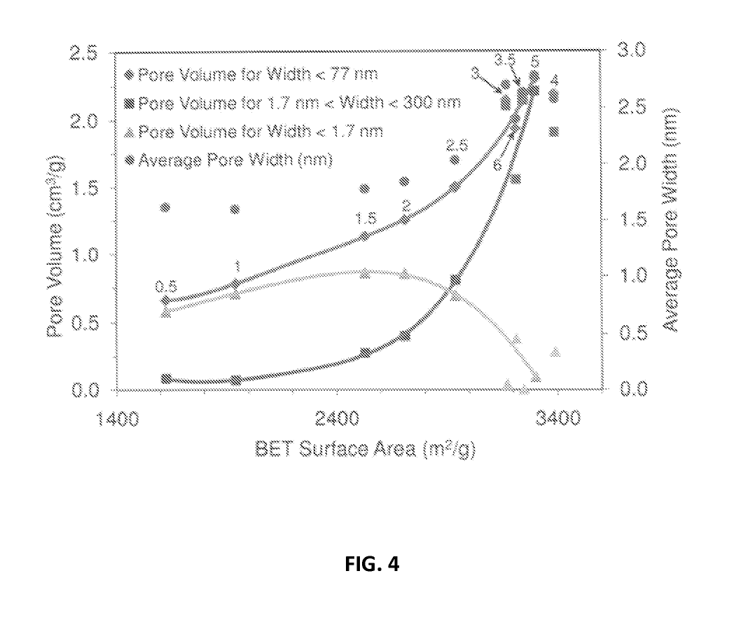

Further, referring to FIG. 4, for the microporous carbon materials corresponding to samples C-1 through C-10, a comparatively larger weight ratio of activation reagent to carbon precursor forms a microporous carbon material defining comparatively larger pore widths and pore volumes, especially in the mesopore range, i.e., pores each having a width of from about 2 nm to about 50 nm. Each microporous carbon material corresponding to samples C-1 through C-10 gradually changes from a micropore-dominated microporous carbon material to a mesopore-dominated carbon material as the weight ratio increases. For example, a highest concentration of micropores occurs at a weight ratio of from about 1.5:1 to 2:1, and corresponds to a BET surface area of 2,530 m²/g to 2,710 m²/g. In contrast, a weight ratio of 5:1 corresponds to a BET surface area of 3,300 m²/g. Without intending to be limited by theory, the increase in surface area at comparatively higher weight ratios is due to the plurality of micropores growing in size, i.e., width, and becoming mesopores during additional etching of the activation reagent during simultaneous activation and carbonization. Such additional etching thus results in a smaller number of micropores.

Duration of Simultaneous Activation and Carbonization

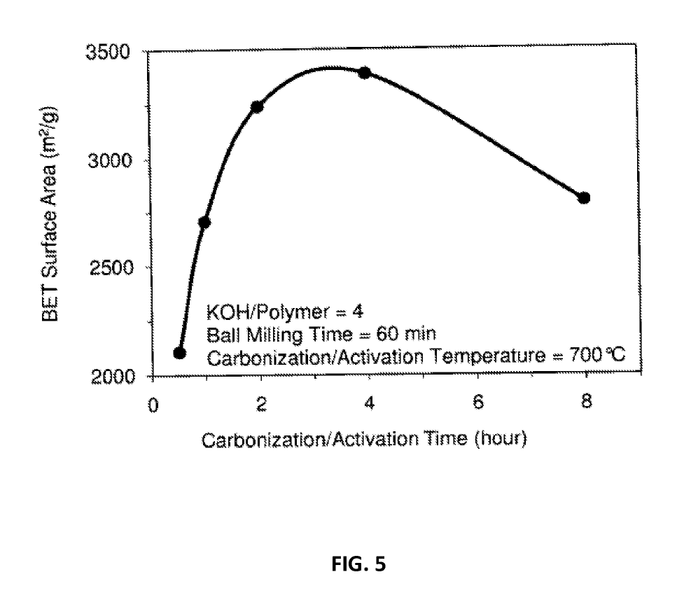

FIG. 5 compares a duration of simultaneous activation and carbonization of each of the composites corresponding to samples C-8 and C-23 through C-26 with respect to BET surface area. As shown in FIG. 5, increasing a duration of simultaneous activation and carbonization causes increasing amounts of carbon to be etched from the carbon precursor. Therefore, both BET surface area and total pore volume increase for a duration of up to about 3 hours (samples C-23 through C-25). However, for durations longer than about 3 hours (samples C-8 and C-26), excessive carbon etching of the carbon precursor by the activation reagent contributes to over-etched pore walls. Such over-etching causes partial collapse of a carbon/pore structure of the carbon precursor and a resulting decrease in BET surface area of the microporous carbon materials.

Temperature of Simultaneous Activation and Carbonization

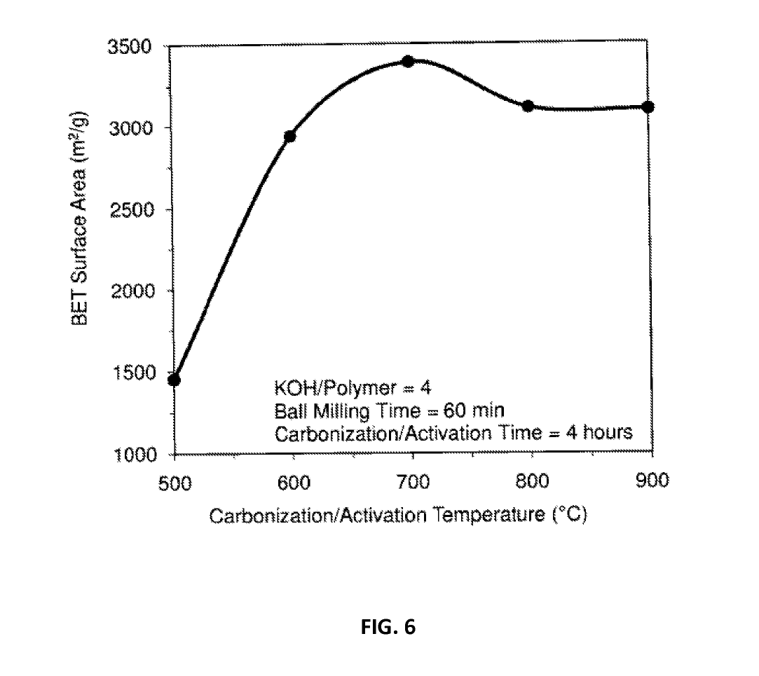

FIG. 6 compares a temperature of simultaneous activation and carbonization of each of the composites corresponding to samples C-8 and C-19 through C-22 with respect to BET surface area. As shown in FIG. 6, at comparatively higher temperatures of simultaneous activation and carbonization, a comparatively more intense reaction occurs between the activation reagent and the carbon precursor. Therefore, BET surface area and total pore volume increase sharply as the temperature of simultaneous activation and carbonization is increased from 500° C. (sample C-19) to 700° C. (sample C-8). At temperatures higher than 700° C. (samples C-21 and C-22), the BET surface area and total pore volume decrease slightly. Without intending to be limited by theory, such decrease may be caused by over-etching, as set forth above and/or a slight shrinkage of the carbon structure of the carbon precursor.

Duration of Ball Milling

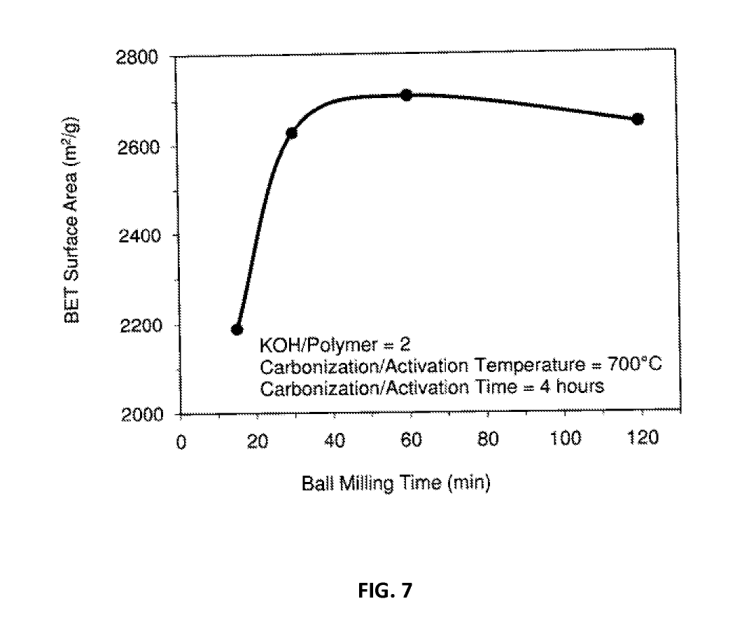

As set forth above, duration of ball milling determines the degree of homogeneity and dispersion of the activation reagent throughout the carbon precursor within the composite. As shown in FIG. 7, as a duration of ball milling of the mixtures corresponding to samples C-11, C-14, and C4 is increased from 15 minutes to 60 minutes, the BET surface area of each resulting microporous carbon material increases from 2,190 m²/g to 2,710 m²/g. Referring again to FIG. 7, BET surface area of the microporous carbon material corresponding to sample C-16 decreases slightly at a ball milling duration of 120 minutes. Such slight BET surface area decrease may be caused by impurities incorporated into the mixture during ball milling to form the composite. For example, 1 part by weight of iron based on 100 parts by weight of the microporous carbon material corresponding to sample C-16 remains after ball milling and simultaneous activation and carbonization of the composite, even after washing the formed microporous carbon material 6 times with diluted hydrochloric acid and water.

Carbon Precursor Average Particle Size

Before ball milling, each carbon precursor corresponding to samples C-11, C-4, and C-16 is ground by hand with a mortar and pestle into particles having an initial average particle size of about 5 mm. After the mixture corresponding to sample C-11 is ball milled for 15 minutes, individual particles of the formed composite have an average particle size of about 100 microns. Further, after ball milling the mixture corresponding to sample C-4 for 60 minutes, individual particles of the formed composite have an average particle size of about 50 microns. Ball milling the mixture corresponding to sample C-16 did not further reduce the average particle size of the formed composite. Therefore, the average particle size of the carbon precursor decreases during ball milling.

Hydrogen Adsorption Capacity

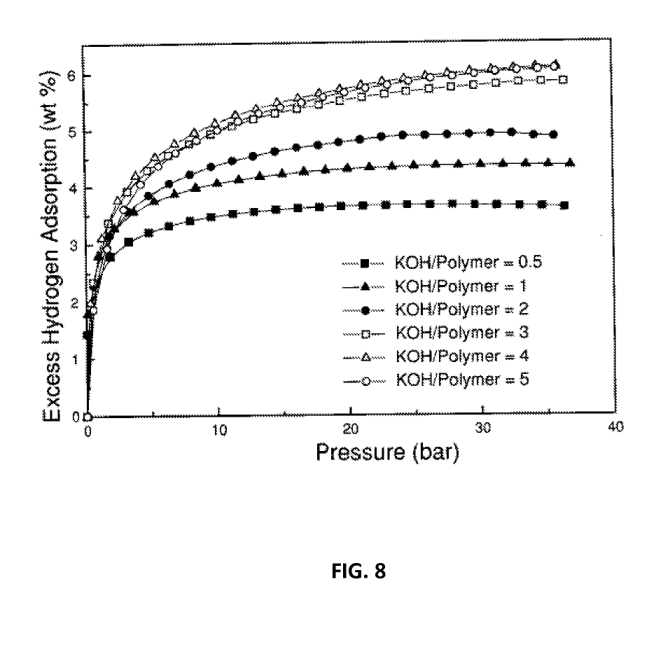

The hydrogen isotherms of FIG. 8 illustrate an amount of hydrogen gas adsorbed on the microporous carbon materials. More specifically, hydrogen adsorption isotherms are measured at a temperature of 77K and a pressure of less than or equal to 35 bars for the microporous carbon materials corresponding to each of samples C-1, C-2, C-4, C-6, C-8, and C-9. As shown in FIG. 8, excess hydrogen adsorption capacity increases as BET surface area increases. That is, the microporous carbon material having a BET surface area of 1,620 m²/g (corresponding to sample C-1) adsorbs about 3.6 wt % hydrogen at 30 bars. In contrast, the microporous carbon material having a BET surface area of 3,390 m²/g (corresponding to sample C-8) adsorbs about 6.0 wt % hydrogen at 30 bars.

Additionally, the weight ratio of activation reagent to carbon precursor affects excess hydrogen adsorption capacity. With reference to FIG. 4, as the weight ratio of activation reagent to carbon precursor increases, pore size of the microporous carbon material also increases. That is, as set forth above, a comparatively larger weight ratio of activation reagent to carbon precursor forms a microporous carbon material defining comparatively larger pore widths and pore volumes, especially in the mesopore range, i.e., pores each having a width of from about 2 nm to about 50 nm. Such increased pore size and pore volume also affects excess hydrogen adsorption capacity.

In particular, for the weight ratio of greater than or equal to 3:1 (samples C-6, C-8, and C-9), the pore size distribution changes from micropore-dominated to mesopore-dominated, as shown in FIGS. 3 and 4. Referring now to FIG. 8, the hydrogen isotherms corresponding to samples C-6, C-8, and C-9 indicate that the microporous carbon materials formed from samples C-6, C-8, and C-9 reach saturation at a comparatively higher pressure than the microporous carbon samples corresponding to samples C-1, C-2, and C-4 having a weight ratio of less than 3:1.

Moreover, a comparison of the microporous carbon materials corresponding to sample C-8 (having a weight ratio of 4:1) and sample C-9 (having a weight ratio of 5:1) indicates that although both microporous carbon materials have similar BET surface areas (3,390 m²/g and 3,300 m²/g, respectively), each microporous carbon material has a different pore size distribution. In particular, the microporous carbon material corresponding to sample C-9 defines relatively less micropores than the microporous carbon material corresponding to sample C-8. Although both microporous carbon materials adsorb about 6.0 wt % hydrogen at 30 bars, the microporous carbon material corresponding to sample C-9 has the comparatively largest pore sizes, and also exhibits a lower excess hydrogen uptake at lower pressures as compared to the microporous carbon material corresponding to sample C-8.

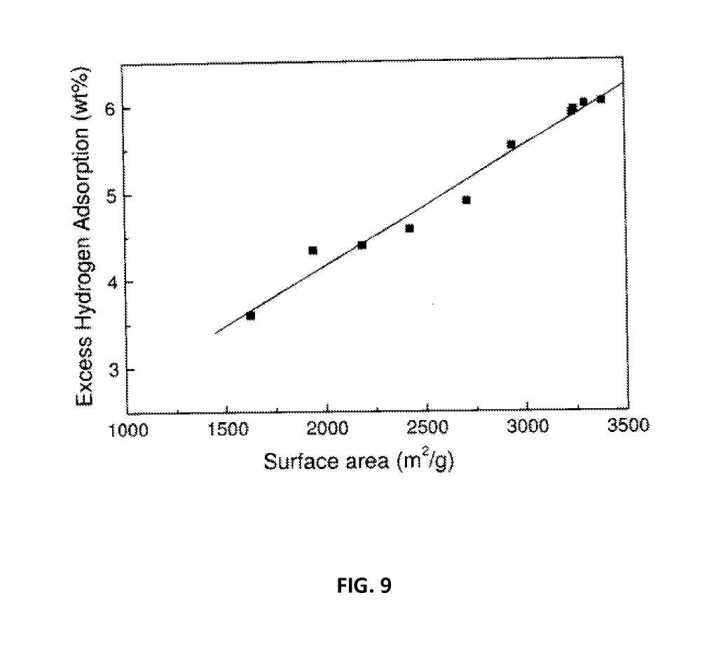

Referring now to FIG. 9, there is a linear correlation between BET surface area and excess hydrogen adsorption capacity of the microporous carbon materials corresponding to each of samples C-1 through C-10. That is, as BET surface area of the microporous carbon materials increases, excess hydrogen adsorption capacity at a temperature of 77K and a pressure of 30 bars of the microporous carbon materials also increases. The microporous carbon materials corresponding to samples C-9 and C-8 have the comparatively highest BET surface areas (3,390 m²/g and 3,300 m²/g, respectively), and each adsorb about 6.0 wt % hydrogen at a temperature of 77K and 30 bars.

While the best modes for carrying out the invention have been described in detail, those familiar with the art to which this invention relates will recognize various alternative designs and embodiments for practicing the invention within the scope of the appended claims.

1. A method of forming a microporous carbon material, the method comprising:
combining a carbon precursor in solid form and an activation reagent in solid form to form a mixture;
ball milling the mixture to form a composite; and
after ball milling, simultaneously activating and carbonizing the composite to form the microporous carbon material.

2. The method of claim 1, further including controlling a surface area of the microporous carbon material to from about 1,400 m²/g to about 3,400 m²/g.

3. The method of claim 2, further including controlling the surface area of the microporous carbon material by controlling a duration of ball milling.

4. The method of claim 3, wherein the duration of ball milling is from about 15 minutes to about 120 minutes.

5. The method of claim 1, wherein ball milling substantially homogeneously disperses the activation reagent in solid form throughout the carbon precursor in solid form to form the composite.

6. The method of claim 1, wherein ball milling reduces an average particle size of the carbon precursor to less than or equal to about 100 microns.

7. The method of claim 2, further including controlling the surface area of the microporous carbon material by controlling a weight ratio of the activation reagent to the carbon precursor.

8. The method of claim 1, wherein combining mixes the activation reagent and the carbon precursor in a weight ratio of activation reagent to carbon precursor of from about 0.5:1 to about 6:1.

9. The method of claim 2, further including controlling the surface area of the microporous carbon material by controlling a temperature of simultaneously activating and carbonizing.

10. The method of claim 2, further including controlling the surface area of the microporous carbon material by controlling a duration of simultaneously activating and carbonizing.

11. The method of claim 1, wherein simultaneously activating and carbonizing the composite heats the composite to a temperature of from about 500° C. to about 900° C. for from about 0.5 hours to about 8 hours.

12. The method of claim 1, wherein simultaneously activating and carbonizing defines a plurality of micropores each having a width of less than about 2 nm, a plurality of mesopores each having a width of from about 2 nm to about 50 nm, and a plurality of macropores each having a width of greater than about 50 nm of the microporous carbon material so that the plurality of micropores are present in the microporous carbon material in an amount greater than or equal to about 90 parts by volume based on 100 parts by volume of the microporous carbon material.

13. The method of claim 1, further including preparing the carbon precursor in solid form before combining, wherein preparing is further defined as reacting phenol and formaldehyde in aqueous solution in the presence of a catalyst to form a phenolic resin oligomer, and washing and drying the phenolic resin oligomer to form a phenolic resin polymer.

14. The method of claim 1, wherein the activation reagent in solid form is selected from the group including potassium hydroxide, sodium hydroxide, potassium carbonate, sodium carbonate, and combinations thereof.

15. The method of claim 1, further including purifying the microporous carbon material after simultaneously activating and carbonizing the composite.

16. A method of forming a microporous carbon material, the method comprising:
combining a phenolic resin polymer in solid form and potassium hydroxide in solid form in a weight ratio of potassium hydroxide to phenolic resin polymer of about 4:1 to form a mixture;
ball milling the mixture in solid form for about 60 minutes to thereby substantially homogeneously disperse the potassium hydroxide in solid form throughout the phenolic resin polymer in solid form to form a composite; and
after ball milling, simultaneously activating and carbonizing the composite at a temperature of about 700° C. for from about 3 hours to about 6 hours to form the microporous carbon material, wherein the microporous carbon material has a surface area of from greater than about 3,000 m²/g to about 3,400 m²/g.

17. A microporous carbon material comprising a reaction product of:
a carbon precursor in solid form; and
an activation reagent in solid form;
wherein the microporous carbon material defines a plurality of micropores each having a width of less than about 2 nm, a plurality of mesopores each having a width of from about 2 nm to about 50 nm, and a plurality of macropores each having a width of greater than about 50 nm;
wherein said plurality of micropores are present in the microporous carbon material in an amount greater than or equal to about 90 parts by volume based on 100 parts by volume of the microporous carbon material; and
wherein the microporous carbon material has a surface area of from about 1,400 m²/g to about 3,400 m²/g.

18. The microporous carbon material of claim 17, wherein the microporous carbon material has an excess hydrogen adsorption capacity at a pressure less than or equal to about 35 bar and a temperature of about 77K of from about 3.6 parts by weight to about 6.0 parts by weight based on 100 parts by weight of hydrogen.

19. The microporous carbon material of claim 17, wherein said carbon precursor is a phenolic resin polymer.

20. The microporous carbon material of claim 17, wherein said activation reagent is potassium hydroxide.
